(19) United States
(12) Patent Application Publication
(10) Pub. No.: US 2018/0300362 A1
(43) Pub. Date: Oct. 18, 2018

(54) DIMENSION DATA INSERTION INTO A DIMENSION TABLE

(71) Applicant: ENTIT SOFTWARE LLC, Sunnyvale, CA (US)

(72) Inventors: Vineetha Vasudevan, Bangalore (IN); Viji Kakkattu Ravindran, Bangalore (IN); Abhilash Radhakrishnaru, Bangalore (IN)

(21) Appl. No.: 15/761,188

(22) PCT Filed: Apr. 1, 2016
(86) PCT No.: PCT/US16/25612

§ 371 Date: Mar. 19, 2018

(30) Foreign Application Priority Data
Nov. 4, 2015 (IN) 5972/CHE/2015

(51) Int. Cl. G06F 17/30

(52) U.S. Cl. CPC G06F 17/30333; G06F 17/30569; G06F 17/30592; G06F 17/30377

(57) ABSTRACT

In some examples, a method includes receiving dimension data for insertion into a dimension table that supports a type 6 slowly changing dimension (SCD) format. The method may also include inserting the dimension data into the dimension table as an additional dimension data record, without updating any other dimension data record already stored in the dimension table.

### BACKGROUND

Recent advances in technology have spurred the generation and storage of immense amounts of data. Corporations may generate immense amounts of data through financial logs, e-mail messages, business records, and the like. As technology continues to develop, search and analysis of relevant data among large data sources may become increasingly difficult. Increasing the efficiency of data systems may improve user experience.

### BRIEF DESCRIPTION OF THE DRAWINGS

Certain examples are described in the following detailed description and in reference to the drawings.

FIG. 1 shows an example of a device that supports dimension data insertion into a dimension table.

FIG. 2 shows an example of dimension data insertion into a dimension table.

FIG. 3 shows an example of dimension data insertion into a dimension table implemented as a time-series fact table.

FIG. 4 shows an example of logical view extraction from a dimension table.

FIG. 5 shows an example of logic that a device or system may implement to support dimension data insertion into a dimension table.

FIG. 6 shows an example of a system that supports dimension table insertion into a dimension table.

### DETAILED DESCRIPTION

The discussion below refers to dimension data, including dimension data subject to change. Dimension data may refer to attribute data of a data management or data warehousing method that is relatively static. Put another way, a dimension data may refer to a collection of reference information about a measurable event. In this context, the events may be referred to as facts, and dimensions may categorize and describe facts and measures, such as time-series facts, measurements, or events. For example, dimensions may support categorization of fact data in ways that support meaningful answers to business question. Some examples of dimension data in a business context may thus include geographical locations of the business, services, terms, customers, products, employees, or various other business attributes that change slowly (e.g., relatively to other business data or transactional data such as sales record data), unpredictably, or irregularly. These dimensions of data may also be referred to as slowly changing dimensions.

Dimension data may be stored in a dimension table. A dimension table may refer to any table or other data structure that stores dimension data. As discussed below, the actual representation of a dimension table may vary, for example taking the form of a time-series fact table or through various other physical implementations. A system may implement a dimension table to store, organize, track, or otherwise manage dimension data according the slowly changing dimension (SCD) format, which includes types 1, 2, 3 as well as other hybrid and combination types of the SCD format. The features described below are provided in a continuing illustration using, as an example, a pure type 6 SCD format for dimension data records stored in a dimension table. However, any of the dimension data insertion, extraction, access, and derivation features described herein may be consistently implemented for other SCD formats that track historical dimension values or any other data management techniques applied to dimension data.

The discussion herein may provide for systems, methods, devices, and logic that support dimension data insertion into dimension table. In particular, the features described herein may provide increased efficiency in dimension data insertion, by implementing insertion of dimension data into a dimension table without updating any other dimension data records already stored in the dimension table. Dimension data insertion without additional updates may be supported even while the dimension table maintains historical dimension data values and corresponding time periods associated with the historical dimension data values. Reducing or eliminating update operations performed on the dimension table may result in increased data management speed and resource efficiency, particularly for database system 8 with a high cost for performing update operations such as column-store databases storing large data volumes.

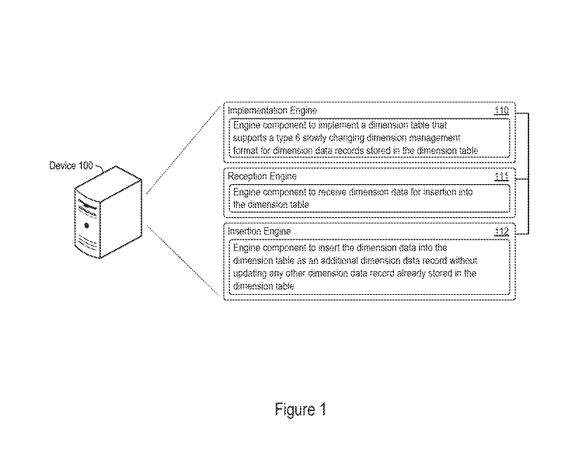

FIG. 1 shows an example of a device 100 that supports dimension data insertion into a dimension table. The device 100 may take the form of a computing system, including a single or multiple computing devices such as application servers, compute nodes, desktop or laptop computers, smart phones or other mobile devices, table devices, embedded controllers, and more. The device 100 may be part of a database system or data warehouse, for example storing dimension data, fact data, or both.

As described in greater detail below, the device 100 may support access to dimension data according to a predefined SCD format, such as pure type 6 SCD, but implement a representation of a dimension table that may provide increased efficiency in maintaining the dimension data. In particular, the device 100 may include logic, engines, or circuitry to implement the dimension table to support dimension data insertions without updating dimension data records already stored in the dimension table. As one example, the device 100 shown in FIG. 1 includes implementation engine 110, reception engine 111, and insertion engine 112. The device 100 may implement the engines 110, 111, and 112 (and components thereof) in various ways, for example as hardware and programming. The programming for the engines 110, 111, and 112 may take the form of processor-executable instructions stored on a non-transitory machine-readable storage medium and the hardware for the engines 110, 111, and 112 may include a processing resource to execute those instructions. A processing resource may take the form of a single-processor or multi-processor resource, for example.

The implementation engine 110 may include an engine component to implement a dimension table that supports a type 6 SCD format for dimension data records stored in the dimension table. The reception engine 111 may include an engine component to receive dimension data for insertion into the dimension table, and the insertion engine 112 may include an engine component to insert the dimension data into the dimension table as an additional dimension data record without updating any other dimension data record already stored in the dimension table. Examples of dimension data insertion that the device 100 may support through the implementation engine 110, reception engine 111, and insertion engine 112 are described in greater detail next.

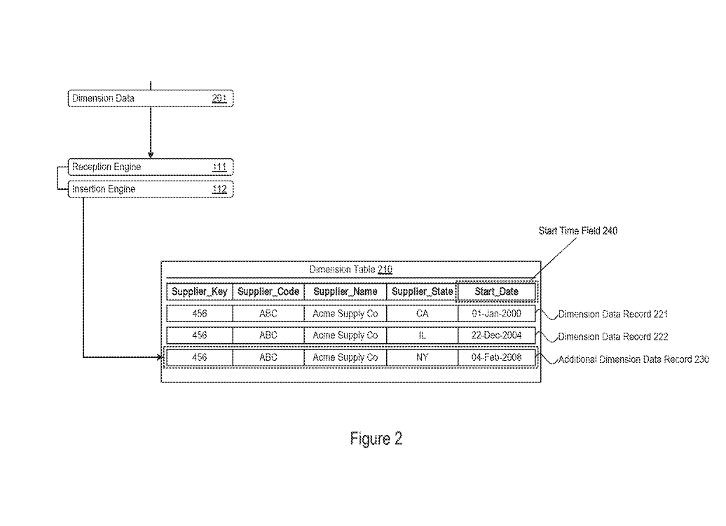

FIG. 2 shows an example of dimension data insertion into a dimension table. In the example shown in FIG. 2, the reception engine 111 receives dimension data 201 for insertion into a dimension table 210. Dimension data received by the reception engine 111 may include any change or update to a dimension attribute tracked by a particular dimension table. As illustrative examples, dimension data may specify a new location for a particular supplier of a business, an updated employee address, the internal product code of a newly-released product version, or any other change to dimension data tracked by the dimension table. In the example shown in FIG. 2, the dimension data 201 indicates a supplier named “Acme Supply Co” moving to the state of New York starting from a start time value of Feb. 4, 2008.

The implementation engine 110 (not shown) may implement the dimension table 210 to support access to dimension data records in a SCD format. Implementation of the dimension table 210 by the implementation engine 110 may refer to any generation, maintaining, or modification of a physical or logical representation of the dimension table 210 to include specific parameters, data fields, or any other table attributes. The dimension table 210 may support tracking the current and historical values of a particular dimension attribute and associated time periods for the various values. As shown in the example in FIG. 2, the dimension table 210 tracks the state location of the supplier coded as “ABC” and named “Acme Supply Co” through the Supplier_State field, tracking historical values in the dimension data records 221 and 222 stored in the dimension table 210.

The implementation engine 110 may also implement the dimension table 210 in a pure type 6 SCD format such that records in the dimension table for the same master data item (e.g., particular dimension attribute values) use the same surrogate key. To illustrate through the example shown in FIG. 2, the “Supplier_Key” field may represent a surrogate key, and dimension data records for each unique supplier (e.g., as identified through a unique natural key stored in the “Supplier_Code” field) may use the same respective surrogate key value. Thus, in this example, the different dimension attribute values of the “Supplier_Code” field may represent different master data items, each with a unique surrogate key. As seen in FIG. 2, each of the dimension data records for the “Supplier _Code” value of “ABC” has a “Supplier_Key” value of “456 ”.

The implementation engine 110 may implement the dimension table 210 to identify a time period for historical dimension values. However, the implementation engine 110 may implement the dimension table 210 such that dimension data records stored in the dimension table 210 include a start time field 230, but not an end time field. The start time field 230 of a dimension table 210 may indicate any date, time, or other temporal indicator as to when a particular dimension value started to take effect. In the example shown in FIG. 2 relating to suppliers, the dimension table 210 includes the start time field 230 through the “Start_Date” field of stored dimension data records, indicating the initial or earliest calendar date at which a supplier was located in a particular state.

By implementing the dimension table 210 to include dimension data records with a start time field 230 but not an end time field, the implementation engine 110 may support insertion of dimension data records into the dimension table 210 without updating any other dimension data records already stored in the dimension table 210. To illustrate through FIG. 2, the insertion engine 112 may insert the additional dimension data record 240 into the dimension table 210, which may add a record in the dimension table 210 for the dimension change specified in the dimension data 201. That is, the insertion engine 112 may insert the additional dimension data record 240 indicating that the supplier named “Acme Supply Co” is located in the state of New York starting from Feb. 4, 2008 without having to update any of the dimension data records 221 and 222 already stored in the dimension table 210. Without an end time field for records in the dimension table 210, the insertion engine 112 or other database management logic need not update the dimension data record tracking the previous location of the Acme Supply Co to indicate when the time when the previous location of the Acme Supply Co ended.

As also shown in FIG. 2, the implementation engine 110 may implement the dimension table 210 so that the dimension data records do not store both a historical dimension value and a current dimension value, as specified by some type 6 SCD implementations. Accordingly, dimension data insertions into the dimension table 210 do not require updating each of the other dimension data records stored in the dimension table 210 to specify newly changed current dimension value. Similarly, the implementation engine 110 may implement the dimension table 210 such that dimension data records do not include a “current record” or “current flag” field indicating which of the dimension data records represents the current dimension value of the dimension. Thus, for dimension data insertions into the dimension table 210, the insertion engine 112 may insert the additional dimension data record 240 without having to update a “current record” field of a previously stored dimension data record, as dimension data records in the dimension table 210 do not include such a field.

Thus, as described above, the insertion engine 112 may insert an additional dimension data record 240 into the dimension table 210 to reflect a dimension value change specified in dimension data 201 received by the reception engine 111. The insertion engine 112 may perform the insertion without updating any other record in the dimension table 210, such as the dimension data records 221 and 222. Insertions into a dimension table 210 may thus be performed without any update operations on the dimension table 210, which may increase the efficiency and speed at which changes to the dimension table 210 are effectuated. Such effects may be particularly impactful for database systems in which update operations incur a relatively high performance cost, for example a database system effectuating update operations through a delete-insertion combination of operations and columnar databases.

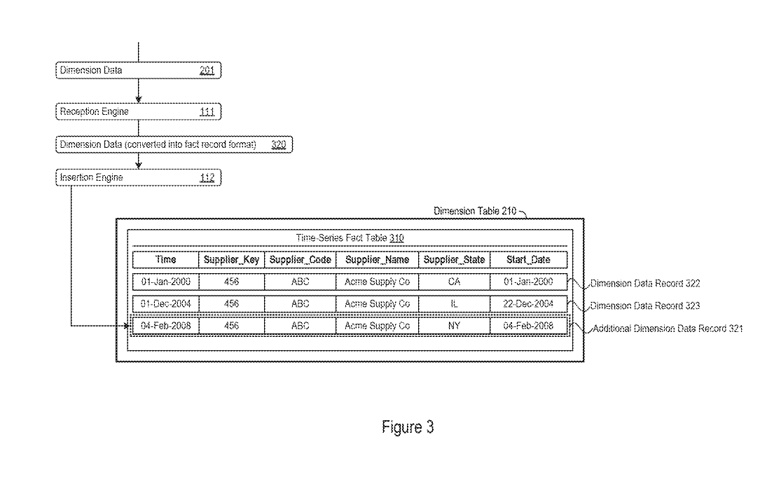

FIG. 3 shows an example of dimension data insertion into a dimension table implemented as a time-series fact table. In some examples, the implementation engine 110 may implement the dimension table 210 as a fact table, such as the time-series fact table 310 shown in FIG. 3. That is, the implementation engine 110 may support a conceptual or logical representation of a dimension table 210, accessible or viewable to a user. However, the actual (e.g., physical) representation of the dimension table 210 generated or maintained by the implementation engine 110 may take the form of a time-series fact table 310, which may include a “time” field for tracking when a particular event occurred. In this example, the event or fact tracked by the time-series fact table 310 may take the form of a change or update to a dimension value. A fact record stored in the time-series fact table 310 may thus be a dimension data record.

To support insertion into a dimension table 210 implemented as a time-series fact table 310, the reception engine 111 may convert the dimension data 201 into a fact record format supported by the time-series fact table 310. As seen in FIG. 3, the reception engine 111 may generate the dimension data (converted into fact record format) 320. The reception engine 111 may do so by adding a data field, removing a data field, or otherwise configuring the dimension data 201 into the fact record format for dimension data records stored in the time-series fact table 310. In the example shown in FIG. 3, dimension data records stored in the time-series fact table 310 include the “time” field indicating when an event or fact in the time-series fact table 310 occurred. As such, the reception engine 111 may add an associated time for the fact or event (e.g., the dimension value change) as part of converting the dimension data 201 into a fact record format supported by the time-series fact table 310. The time may indicate when the dimension value change is to occur or when the record was inserted into the time-series fact table 310.

The insertion engine 112 may insert the dimension data (converted into the fact record format) 320 as an additional dimension data record 321 in the time-series fact table 310. The insertion engine 112 may do so without updating any of the other dimension data records 322 and 323 already (e.g., previously) stored in the time-series fact table 310. Thus, the time-series fact table 310 may represent the dimension table 210 and persist the dimension history of a dimension while supporting dimension data record insertions without updating any other dimension data records already stored in the time-series fact table 310.

Although dimension data records stored in the dimension table 210 may not include an end time field, the dimension table 210 may nonetheless support derivation of a time period for historical dimension values stored in the dimension table 210. Example derivation features in the context of accessing dimension data are described next.

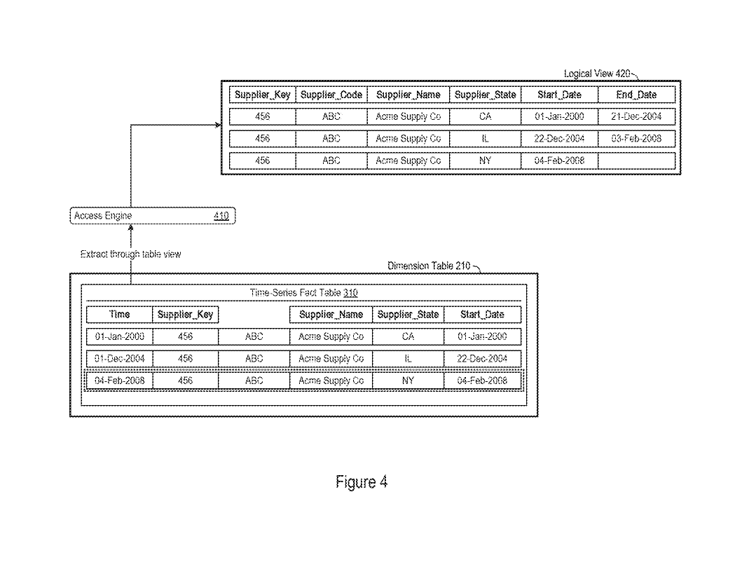

FIG. 4 shows an example of logical view extraction from a dimension table 210. In the example shown in FIG. 4, an access engine 410 may extract dimension data stored in a dimension table 210. The access engine 410 may be implemented as part of a database system, such as a data warehouse. In that regard, the access engine 410 may include hardware and programming to implement any of the dimension table access features described herein.

The access engine 410 may extract dimension data from the dimension table 210 through a table view, which may refer to a virtualized table with contents defined by a query. In that regard, the access engine 410 may provide dimension data according to a pure type 6 SCD format by extracting the dimension data from the dimension table 210. As seen in FIG. 4, the access engine 410 presents the logical view 420 of dimension data stored in the dimension table 210. In the example shown in FIG. 4, the access engine 410 presents the logical view 420 of the dimension data according to the pure type 6 SCD format.

In extracting the dimension data, the access engine 410 may derive end times for various historical dimension values of a dimension. That is, the access engine 410 may extract the dimension data records stored in the dimension table 210, and in doing so derive an end time value for a particular dimension data record stored in the dimension table from a start time value of another dimension data record stored in the dimension table that is subsequent to the particular dimension data record. The access engine 410 may then present the extracted dimension data records, including the derived end time value for the particular dimension record, as the logical view 420 of the dimension table 210.

A subsequent dimension data record may refer to a dimension data record that was stored subsequently or later in time than the particular dimension data record, which may be reflected in the ordering of the dimension data records in the dimension table 210 when ordered by start time value or through the time field of a time-series fact table 310. Thus, in some implementations, the dimension data record subsequent to the particular dimension data record may refer to the dimension data record stored in the next, subsequent row in the dimension table 210 or the dimension data record with a time data later in time than the time data of the particular dimension data record. Along similar lines, a previous dimension data record may refer to a dimension data record that was inserted into the dimension table 210 at an earlier time or stored in a previous row of the dimension table 210.

To illustrate through FIG. 4, the access engine 410 may derive an end time value for the dimension data record 322 from the start time value stored in the start time field of the dimension data record 323, which is subsequent to the dimension data record 322 (as the dimension data record 323 is inserted later in time and stored in a subsequent row of the dimension table 210). In particular, the access engine 410 may identify the start time value of the dimension data record 323 as “22-Dec-2004” and identify the end time value of the dimension data record 322 as a previous time value. In the logical view 420, the access engine 410 presents the derived end time value for the dimension data record 322 as “21-Dec-2004”.

In a similar way, the access engine 410 may derive end time values for the dimension data records stored in the dimension table 210, aside from the dimension data record storing the current value of the tracked dimension attribute. This may be the case as the dimension data record storing the current value of the dimension attribute may have the latest time data of any dimension data record stored in the dimension table 210, and thus without a subsequent dimension data record to derive the end time value from. For the dimension data record storing the current value of the dimension attribute, the access engine 410 may present the end time value as blank in the logical view 420, thus indicating the dimension data record as storing the current value (e.g., the current supplier state of “NY” as shown in the logical view 420 shown in FIG. 4).

As noted above, the access engine 410 may support access to the dimension data records stored in the dimension table 210 through a table view. The query defining the table view may derive the end time values presented through the logical view 420, and the access engine 410 may implement or execute the table view query to derive the end time values for dimension data records of the dimension table 210. As one example according to the supplier dimension table shown in FIG. 4, the access engine 410 may utilize the following example table view:

```
CREATE View supplier_pure_scd6(
  Supplier_Key, Supplier_Code, Supplier_Name,
  Supplier_State, Start_Date, End_Date) as
  Select Supplier_Key, Supplier_Code, Supplier_Name,
    Supplier_State, ta_period as start_date,
    LEAD(start_date) OVER (PARTITION BY dsi_key_id
    order by start_date) + INTERVAL ‘-1 second’ as
    end_date from supplier_pure_scd6_fact;
```

In the example above, the table view supplier_pure_scd6 may extract dimension data from the fact table named supplier_pure_scd6 _fact, deriving the end_date values for the dimension data records of the table view.

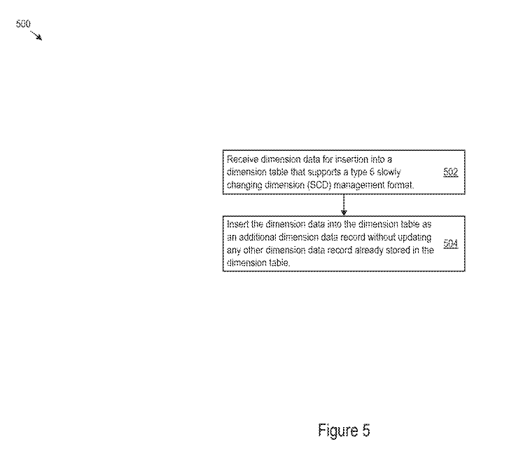

FIG. 5 shows an example of logic 500 that a system or device may implement to support dimension data insertion into a dimension table 210. For example, the device 100 may implement the logic 500 as hardware, executable instructions stored on a machine-readable medium, or as combinations thereof. The device 100 may implement the logic 500 through the reception engine 111 and insertion engine 112, for example, through which the device 100 may perform or execute the logic 500 as a method to insert a dimension data record into a dimension table 210.

In implementing the logic 500, the reception engine 111 may receive dimension data for insertion into a dimension table that supports a type 6 SCD management format (502). The insertion engine 112 may insert the dimension data into the dimension table as an additional dimension data record without updating any other dimension data record already stored in the dimension table 210 (504)

In some examples, the logic 500 may further include implementing the dimension table such that dimension data records stored in the dimension table do not include an end time field, e.g., as performed by implementation engine 110. As such, the insertion engine 112 may insert the dimension data into the dimension table 210 without updating an end time field of any dimension data records stored in the dimension table 210. In other examples, the insertion engine 112 may insert the dimension data into the dimension table without updating a current record field of any dimension data records in the dimension table, such as when the implementation engine 110 implements the dimension table 210 such that dimension data records do not include a current record field.

The logic 500 may further include implementing the dimension table 210 as a fact table, such as time-series fact table 310. When the implementation engine 110 does so, the reception engine 111 may convert the dimension data to a fact record format compatible with the fact table after receiving the dimension data and the insertion engine 112 may insert into the fact table implementing the dimension table, the dimension data that was converted into the fact record format.

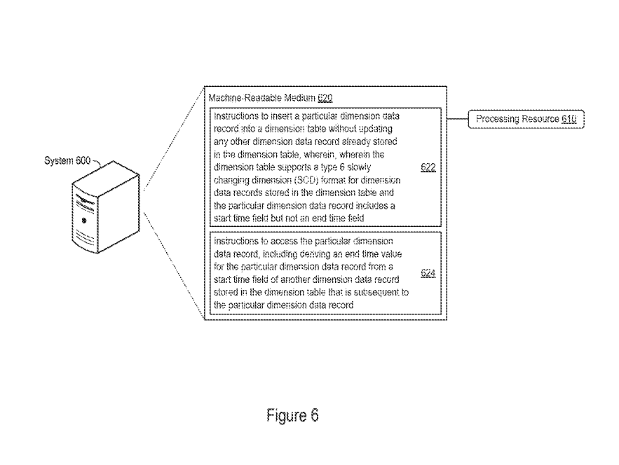

FIG. 6 shows an example of a system 600 that supports dimension data insertion into a dimension table 210. In that regard, the system 600 may support insertion of dimension data records into the dimension table 210 that provides type 6 SCD management without updating any other dimension data record already stored in the dimension table 210. The system 600 may include a processing resource 610 which may take the form of a single or multiple processors. The processors may include a central processing unit (CPU), microprocessor, or any hardware device suitable for executing instructions stored on a machine-readable medium. The system 600 may include a machine-readable medium 620. The machine-readable medium 620 may take the form of any non-transitory electronic, magnetic, optical, or other physical storage device that stores executable instructions, such as the instructions 622 and 624 shown in FIG. 6. As such, the machine-readable medium 620 may be, for example, Random Access Memory (RAM) such as a dynamic RAM (DRAM), flash memory, memristor memory, spin-transfer torque memory, an Electrically-Erasable Programmable Read-Only Memory (EEPROM), a storage drive, an optical disk, and the like.

The system 600 may execute instructions stored on the machine-readable medium 620 through the processing resource 610. Executing the instructions may cause the system 600 to perform any of the dimension data insertion features described herein, including according to any of the features with respect to the implementation engine 110, the reception engine 111, the insertion engine 112, the access engine 410, or any combination thereof. For example, execution of the instructions 622 by the processing resource 610 may cause the system 600 to insert a particular dimension data record into a dimension table 210 without updating any other dimension data record already stored in the dimension table 210, wherein the dimension table 210 supports a type 6 SCD format for dimension data records stored in the dimension table 210 and the particular dimension data record includes a start time field but not an end time field. Execution of the instructions 624 may cause the system 600 to access the particular dimension data record, including deriving an end time value for the particular dimension data record from a start time field of another dimension data record stored in the dimension table 210 that is subsequent to the particular dimension data record.

In some examples, the machine-readable medium 620 may further include executable instructions that cause the system 600 to implement the dimension table 210 as a time-series fact table; convert dimension data of the particular dimension data record into a fact record format compatible with the time-series fact table; and insert, as the particular dimension data record, the dimension data converted into the fact record format.

The systems, methods, devices, and logic described above, including the implementation engine 110, reception engine 111, insertion engine 112, and access engine 410, may be implemented in many different ways in many different combinations of hardware, logic, circuitry, and executable instructions stored on a machine-readable medium. For example, the implementation engine 110, reception engine 111, insertion engine 112, access engine 410, or combinations thereof, may include circuitry in a controller, a microprocessor, or an application specific integrated circuit (ASIC), or may be implemented with discrete logic or components, or a combination of other types of analog or digital circuitry, combined on a single integrated circuit or distributed among multiple integrated circuits. A product, such as a computer program product, may include a storage medium and machine readable instructions stored on the medium, which when executed in an endpoint, computer system, or other device, cause the device to perform operations according to any of the description above, including according to any features of the implementation engine 110, reception engine 111, insertion engine 112, access engine 410, or combinations thereof.

The processing capability of the systems, devices, and engines described herein, including the implementation engine 110, reception engine 111, insertion engine 112, and access engine 410, may be distributed among multiple system components, such as among multiple processors and memories, optionally including multiple distributed processing systems. Parameters, databases, and other data structures may be separately stored and managed, may be incorporated into a single memory or database, may be logically and physically organized in many different ways, and may implemented in many ways, including data structures such as linked lists, hash tables, or implicit storage mechanisms. Programs may be parts (e.g., subroutines) of a single program, separate programs, distributed across several memories and processors, or implemented in many different ways, such as in a library (e.g., a shared library).

While various examples have been described above, many more implementations are possible.

1. A method comprising:
receiving dimension data for insertion into a dimension table that supports a type 6 slowly changing dimension (SCD) format; and
inserting the dimension data into the dimension table as an additional dimension data record without updating any other dimension data record already stored in the dimension table.

2. The method of claim 1, wherein inserting comprises inserting the dimension data into the dimension table without updating an end time field of any dimension data records in the dimension table.

3. The method of claim 1, wherein inserting comprises inserting the dimension data into the dimension table without updating a current record field of any dimension data records in the dimension table.

4. The method of claim 1, further comprising implementing the dimension table such that dimension data records stored in the dimension table do not include an end time field.

5. The method of claim 1, further comprising implementing the dimension table as a fact table.

6. The method of claim 5, further comprising, after receiving the dimension data, converting the dimension data to a fact record format compatible with the fact table.

7. The method of claim 6, wherein inserting the dimension data into the dimension table comprises:
inserting, into the fact table implementing the dimension table, the dimension data that was converted into the fact record format.

8. A device comprising:
an implementation engine to implement a dimension table that supports a type 6 slowly changing dimension (SCD) format for dimension data records stored in the dimension table;
a reception engine to receive dimension data for insertion into the dimension table; and
a insertion engine to insert the dimension data into the dimension table as an additional dimension data record without updating any other dimension data record already stored in the dimension table.

9. The device of claim 8, wherein the implementation engine is to implement the dimension table so the dimension data records stored in the dimension table include a start time field, but not an end time field.

10. The device of claim 8, wherein the implementation engine is to implement the dimension table to support a type 6 SCD format that does not include a historical data field for the data dimension records stored in the dimension table.

11. The device of claim 8, wherein the implementation engine is to implement the dimension table to support a type 6 SCD format that uses a single surrogate key for dimension data records with the same master data item.

12. The device of claim 8, wherein:
the implementation engine is to implement the dimension table as a time-series fact table;
the reception engine is further to convert the dimension data into a fact record format compatible with the time-series fact table; and
the insertion engine is to insert, as the additional dimension data record, the dimension data converted into the fact record format.

13. The device of claim 8, further comprising an access engine to:
extract the dimension data records stored in the dimension table, including deriving an end time value for a particular dimension data record stored in the dimension table from a start time value of another dimension data record stored in the dimension table that is subsequent to the particular dimension data record; and
present the extracted dimension data records, including the derived end time value for the particular dimension record, as a logical view of the dimension table.

14. A non-transitory machine-readable medium comprising executable instructions to:
insert a particular dimension data record into a dimension table without updating any other dimension data record already stored in the dimension table, wherein:
the dimension table supports a type 6 slowly changing dimension (SCD) format for dimension data records stored in the dimension table; and
the particular dimension data record includes a start time field but not an end time field; and
access the particular dimension data record, including deriving an end time value for the particular dimension data record from a start time field of another dimension data record stored in the dimension table that is subsequent to the particular dimension data record.

15. The non-transitory machine-readable medium of claim 14, wherein the instructions are further to:
implement the dimension table as a time-series fact table;
convert dimension data of the particular dimension data record into a fact record format compatible with the time-series fact table; and
insert, as the particular dimension data record, the dimension data converted into the fact record format.
